(19) United States
(12) Patent Application Publication
(10) Pub. No.: US 2009/0181128 A1
(43) Pub. Date: Jul. 16, 2009

(54) CONSUMABLE PRODUCT

(75) Inventors: Alexander Joseph BLUMENTHAL, Hummelstown, PA (US); Malathy NAIR, Hummelstown, PA (US)

Correspondence Address: MCNEES WALLACE & NURICK LLC, 100 PINE STREET, P.O. BOX 1166, HARRISBURG, PA, 17108-1166, US

(73) Assignee: BETTER BOWLS, Hummelstown, PA (US)

(21) Appl. No.: 12/274,753

(22) Filed: Nov. 20, 2008

Related U.S. Application Data
(60) Provisional application No. 61/020,221, filed on Jan. 10, 2008.
(60) Provisional application No. 61/026,757, filed on Feb. 7, 2008.
(60) Provisional application No. 61/040,419, filed on Mar. 28, 2008.
(60) Provisional application No. 61/133,576, filed on Jul. 1, 2008.

(51) Int. Cl. A23L 1/29; A23L 1/03; A23L 1/035; A23L 1/05; A23L 1/187

(52) U.S. Cl. 426/72; 426/573; 426/576; 426/579; 426/74; 426/519

(57) ABSTRACT

A composition includes a delivery vehicle including a caloric component, a functional component, and a matrix-forming component, the matrix-forming component being selected from the group consisting of a thickening agent, a gelling agent, an emulsifier, and combinations thereof, each of the caloric component and the functional component being substantially homogenously mixed within the delivery vehicle and being compatible with the matrix forming component. Each of the caloric component, the functional component, and the matrix-forming component has been compatibilized together. The delivery vehicle is arranged and disposed to receive an additive component thereby producing a substantially solid consumable product upon manual agitation.

### CROSS-REFERENCE TO RELATED APPLICATIONS

This application claims priority to and the benefit of U.S. Provisional Application No. 61/020,221, entitled “RTM (READY-TO-MIX) FORMULATION, PROCESSING AND PACKAGING FOR TWO-STEP, SINGLE-PHASE VISCOUS AND HOMOGENOUS DRY MIX PRODUCTS”, filed Jan. 10, 2008, U.S. Provisional Application No. 61/026,757, entitled “RTM (READY-TO-MIX) FORMULATION, PROCESSING AND PACKAGING FOR TWO-STEP, SINGLE-PHASE VISCOUS AND HOMOGENOUS DRY MIX PRODUCTS”, filed Feb. 7, 2008, U.S. Provisional Application No. 61/040,419, entitled “RTM (READY-TO-MIX) FORMULATION, PROCESSING AND PACKAGING FOR TWO-STEP, SINGLE-PHASE VISCOUS AND HOMOGENOUS DRY MIX PRODUCTS” filed Mar. 28, 2008, which are all hereby incorporated by reference in their entirety, and U.S. Provisional Application No. 61/133,576, entitled “USE OF GELATIN DRY MIX POWDERS OR READY TO EAT GELATIVE PRODUCT AS A DELIVERY VEHICLE FOR NUTRITIONAL AND FUNCTIONAL INGREDIENTS, THERBY ENHANCING THE OVERALL NUTRITIVE VALUE OF THE FOOD PRODUCT”, filed Jul. 1, 2008 which are all hereby incorporated by reference in their entirety.

### FIELD OF THE DISCLOSURE

The present disclosure is directed to a consumable product. More particularly, the present disclosure is directed to a substantially solid consumable product with health benefits.

### BACKGROUND OF THE DISCLOSURE

Dry mixes are well known in food, dietary supplement, and drug delivery industries. The known liquid concentrate relies upon a glycerine wetting agent to facilitate dilution of the liquid concentrate upon the addition of water to produce a liquid. The known liquid concentrate is neither a health food nor a dietary supplement. Liquid consumable products suffer from the drawback that they are quickly excreted through the human body and are not able to be fully absorbed by the human body. In addition, liquid consumable products provide a lesser feeling of fullness or satiation than provided by solid foods. Furthermore, there is a limit to how much liquid consumable product the human body can consume during a day.

Another known consumable product system uses a yogurt-like product in a container. The yogurt-like product is prepared by shaking the container containing the product. The required shaking of the container limits the applications of the yogurt like product. The yogurt-like product is neither a dietary supplement nor a drug delivery device.

Yet, another known consumable system contains a phosphate setting or gelling agent that reacts with milk proteins to form a gel for cheesecake. The cheesecake product is not a health food, dietary supplement, nor a drug delivery device.

Still another known consumable system is configured for an aqueous fluid and ice to be added to a mix while providing agitation with an electric blender thereby producing the consumable product that is in liquid form. This product is unable to be prepared without the combination of ice and agitation with the electrical blender. The drink product is not a health food, dietary supplement, nor a drug delivery device.

There is currently no known product that permits a consumer to conveniently create a substantially solid and nutritionally enhanced food product that primarily uses thickening and gelling agents to create a matrix. Commercially available convenient food products lack a nutritional component, while alternative products that deliver nutritional components are simply mixed together and lack ease and convenience of preparation. Furthermore, the products formed by simply mixing ingredients together with a nutritional component suffer from the drawback that the product experiences reduced nutritional efficacy due to segregation of functional components or other incompatibilities between ingredients. In addition, known products further suffer from the drawback of difficulty in handling and short shelf life.

Therefore, there is an unmet need to provide a substantially solid consumable product, a substantially solid consumable product system, and a method of preparing a substantially solid consumable product in substantially solid form that may be used for producing a health food, for producing a dietary supplement and/or as a drug delivery device, without requiring electrical mixing, heat supplied mixing, cool mixing, catalyst aided mixing, or combinations thereof.

### SUMMARY OF THE DISCLOSURE

This disclosure provides a substantially solid consumable product, a substantially solid consumable product system, and a method of preparing a substantially solid consumable product in substantially solid form that may be used for producing a health food, for producing a dietary supplement and/or as a drug delivery device, without requiring electrical mixing, heat supplied mixing, cool mixing, catalyst aided mixing, or combinations thereof.

According to an embodiment, a composition includes a delivery vehicle including a caloric component, a functional component, and a matrix-forming component, the matrix-forming component being selected from the group consisting of a thickening agent, a gelling agent, an emulsifier, and combinations thereof, each of the caloric component and the functional component being substantially homogenously mixed within the delivery vehicle and being compatible with the matrix forming component. Each of the caloric component, the functional component, and the matrix-forming component has been compatibilized together. In addition, the delivery vehicle is arranged and disposed to receive an additive component thereby producing a substantially solid consumable product upon manual agitation.

According to another embodiment, a substantially solid consumable product system includes a composition and a housing arranged for receiving the additive component and disposed for securing the substantially solid consumable product. The composition includes a delivery vehicle including a caloric component, a functional component, and a matrix-forming component, the matrix-forming component being selected from the group consisting of a thickening agent, a gelling agent, an emulsifier, and combinations thereof, each of the caloric component and the functional component being substantially homogenously mixed within the delivery vehicle and being compatible with the matrix forming component. Each of the caloric component, the functional component, and the matrix-forming component has been compatibilized together. In addition, the delivery vehicle is arranged and disposed to receive an additive component thereby producing a substantially solid consumable product upon manual agitation.

According to yet another embodiment, a method of preparing a substantially solid consumable product includes providing a composition and mixing the liquid with the composition by manually agitating the liquid thereby producing the substantially solid consumable product. The composition includes a delivery vehicle including a caloric component, a functional component, and a matrix-forming component, the matrix-forming component being selected from the group consisting of a thickening agent, a gelling agent, an emulsifier, and combinations thereof, each of the caloric component and the functional component being substantially homogenously mixed within the delivery vehicle and being compatible with the matrix forming component. The method includes compatibilizing together at least a portion of each of the caloric component, the functional component, and the matrix-forming component and arranging and disposing the delivery vehicle in a housing to receive an additive component. Thereafter, the additive component is provided to the delivery vehicle and the additive component and delivery vehicle are manually agitated thereby producing a substantially solid consumable product.

An advantage of the present disclosure is extended absorption of caloric and functional components due to substantially solid nature of the delivery vehicle.

Another advantage of the present disclosure is increased satiation due to the substantially solid nature of the delivery vehicle.

Yet another advantage of the present disclosure is ease of preparing healthy substantially solid consumable products by requiring manual agitation but not requiring electrical mixing, heat supplied mixing, cool mixing, catalyst aided mixing, and combinations thereof.

Still another advantage of the present disclosure is permitting measured servings, providing consistent and desired amount of functional and other components.

Still yet another advantage of the present disclosure is fortifying a substantially solid consumable product while not appreciably sacrificing taste, appearance, and/or texture.

Still yet another advantage of certain embodiments of the present disclosure is increased shelf-life of natural flavors and non-synthetic colors as well as other components including functional ingredients.

Further aspects of the system and apparatus are disclosed herein. The features as discussed above, as well as other features and advantages of the present disclosure will be appreciated and understood by those skilled in the art from the following detailed description and drawings.

### BRIEF DESCRIPTION OF THE DRAWINGS

FIG. 1 graphically illustrates a method according to an embodiment of the present disclosure.

### DETAILED DESCRIPTION OF THE DISCLOSURE

An embodiment of the present disclosure includes a substantially solid consumable product. The substantially solid consumable product includes a delivery vehicle and an additive component. The delivery vehicle may include a functional component, a caloric component, and a matrix-forming component. As used herein, the term “substantially solid consumable product” includes any solid consumable products and any substantially solid consumable product, such as, by way of example only, gelatin. In one embodiment, the viscosity of the substantially solid consumable product may permit consumption by using a utensil, such as a spoon or fork.

In one embodiment, the delivery vehicle may be included in a housing. The housing may be configured to receive the additive component with little or no loss of delivery vehicle. The housing further secures or otherwise retains the formed substantially solid consumable product. For instance, the delivery vehicle may be adhered to the internal surface of a bowl in a pre-measured quantity where the housing, package for the housing or other structure related to the housing has a line or other indicia indicating the appropriate amount of liquid to be added to the delivery vehicle to produce the substantially solid consumable product. In this embodiment, the housing and the delivery vehicle may reduce the weight of the product. As such, the cost of shipping, by not shipping the additive component (such as water) with the delivery vehicle may be reduced. Examples of the housing include a container, a bowl, a cup, or other systems of holding the substantially solid consumable product. The size of the housing and/or indicators on the housing may be specific to serving sizes, specific nutritional/drug dosages, volumetric sizes (such as a cup), and/or dependent upon the liquid or other additive component to be added. Additionally or alternatively, a dissolvable package and/or an edible package including the delivery vehicle may be provided. The dissolvable packages are desirable when adding additions, such as, omega-3 fish oils, leavening agents, Pop-Rocks® (a registered trademark owned by Zeta Espacial S.A.), and/or interactive color/flavoring ingredients. The housing may be configured to house multiple embodiments of the substantially solid consumable product, may be configured for specific liquids or other additive components, may be configured to further aid in stirring (for instance, by leaving an unoccupied volume at the top of the housing), and/or may include an unoccupied volume for the toppings to be added to the substantially solid consumable product. The housing may be microwaveable or otherwise configured to hold heated or boiling liquid. The housing may be configured to be dishwasher-safe. The housing may be made of a material that extends shelf-life by preventing migrating and/or oxidation. The housing may be configured for being held in a hand while being stirred. The housing may be shrink-wrapped or otherwise packaged to reduce or prevent burning of the consumer, such as from heating the housing in a microwave. The package may include a film seal in addition to or instead of a lid (which may be a twist on lid, a snap on lid, or any other lid), thereby providing easier preparation, storage, and reuse of the housing. The housing may include mechanical features, such as, collapsibility, thereby providing space reduction and may protect the delivery vehicle against degradation by light, heat moisture, and/or oxidation.

The matrix-forming component is arranged and disposed for forming a matrix of the substantially solid consumable product when combined with an additive component. The matrix-forming component may include a cohesive agent that allows for absorption and binding of the additive component, such as a thickening agent, emulsifier, a gelling agent, or a combination thereof. The addition of a cohesive agent is desirable for foods that do not have natural thickening properties as are known in mashed potatoes and oatmeal. The matrix-component is not limited to a single ingredient and may include a plurality of ingredients that support, form or otherwise enhance the formation and structure of the matrix. The delivery vehicle receives the additive component thereby producing the substantially solid consumable product upon manual agitation. It is desirable that the delivery vehicle be rapidly soluble and/or dispersible in the additive component. It is desirable to form a homogenous mix of the matrix-forming component with the caloric component and the functional component by a process such as agglomeration prior to mixing with the additive component. The agglomerated, homogenous mix may better facilitate solubility, uniform dispersability of all components, and/or formation of the substantially homogenous substantially solid consumable product. In embodiments with the matrix including the caloric component and/or the functional component, the substantially solid consumable product includes the features of the caloric component and/or the functional component, respectively.

In one embodiment including the gelling agent as the matrix-forming component and fiber as the functional component, the substantially solid consumable product may be formed by the solidification of the matrix-forming component manually agitated with the additive component at a temperature between about 145° F. and about 160° F., which is subsequently cooled. While not so limited, the weight percent of the gelling agent in the gelatin matrix may be between about 12% and about 13% in the matrix being gelatin, the caloric component being a weight percent of about 65% to about 70% of the matrix, and about 1% to about 2% in the matrix being citric acid, about 1% to about 1.5% in the matrix being sodium citrate, and about 15% to 20% of the matrix being soluble corn fiber. At such concentrations, the gelling agent may produce a substantially solid consumable composition while only requiring manual agitation. The term “manual agitation” as used herein includes mixing without an external energy supply and does not include electrical mixing, catalyst-aided mixing, and combinations thereof. Manual agitation includes, but is not limited to, stirring by hand.

The caloric component, which is configured to be substantially homogenously mixed into the delivery vehicle, may have features providing energy when consumed by a human. Suitable caloric components may include edible materials containing calories, carbohydrates, functional lipids, and/or sugars or flavor enhancers (including, but not limited to, cocoa). In an embodiment, the weight percent of the caloric component may be at least about 60% to about 65% of the matrix, especially when sugar is included, to as little as 3% of the matrix, when free of or substantially free of sugar. One particularly suitable caloric component may include, but not be limited to, sugar. Another suitable caloric component may include sugar and fructose thereby providing lower glycemic response and enhanced sweetness perception, while controlling the amount of calories to specifically counteract less desirable flavors including, but not limited to, barny or hay flavors from proteins. Additionally or alternatively, the consumable product may be limited to containing natural colors and flavors as opposed to including artificial colors and/or flavors. To permit the consumable product to be substantially devoid of artificial colors and/or flavors, yet still have enhanced color or flavor, the selection of natural flavors and./or colors embedded within the matrix component is such that the natural flavors and/or colors are compatible with the rest of the delivery vehicle composition and processing without diminishing features associated with specific substantially solid consumable products. For instance, as disclosed below in the Example section, the clarity of the consumable product may be affected by certain natural flavors. In these embodiments, specific processing of the flavors may be used to allow clarity.

The functional component is configured to be substantially homogenously mixed into the delivery vehicle. The functional component may provide functional features, such as, nutritive features, satiating features, sensory features (including, but not limited to taste, flavors, color, and texture), water absorption, caloric density, promotion of specialty ingredients (including, but not limited to, proteins; fiber; functional lipids; heart health promoting ingredients such as phyto sterols and omega 3 acids; brain health enhancing ingredients such as DHA; bone health enhancing ingredients such as vitamin D and calcium; arthritis retarding ingredients such as specific gelatin fractions; sleep enhancing dairy protein fractions; antioxidant extracts such as green tea, white tea; antioxidant vitamin blends including vitamins A, C, and E; antioxidant fruit extracts such as acai, gogiberry; immunity enhancing vitamin blends; alertness enhancing agents such as caffeine or guarana; eye health promoting ingredients such as lutein; electrolyte blends such as potassium, zinc, magnesium, and other minerals; dry fruit or vegetable powder, pre and probiotic cultures to promote gut and digestive health; whole grains; water soluble clear proteins; and satiety enhancing ingredients such as oat oil fractionated components). In the specific embodiment including fiber as the functional component, synergistic blends of combinations of fibers may be used in a single serving to remain below levels that claim to provide gastric discomfort. It is desirable that the functional component be water-soluble. In one embodiment, micronizing ingredients or micro or nanoencapsulated ingredients may also be included. Use of nanotechnology or other encapsulation methods may provide enhanced shelf-life and/or improved sensory quality.

Ingredient concentrations for alternate exemplary embodiments of the present disclosure are shown in TABLE 1 for pudding and gelatin systems.

TABLE 1

| Delivery Vehicle | Puddings | Gelatins |
|---|---|---|
| Delivery Vehicle % | | |
| Regular | 19% | 20% |
| Sugar-Free | 9-11% | 8% |
| Matrix Component | | |
| Regular | 19-27% | 12-13% |
| Sugar-Free | 47-52% | 37-39% |
| Functional Component | | |
| Regular | 18-19% | 21-22% |
| Sugar-Free | 35-43% | 62-64% |
| Caloric Component | | |
| Regular | 54-63% | 65-66% |
| Sugar-Free | 6-12% | 0.4% |

The delivery vehicle may comprise from about 4% to about 25% of the substantially solid consumable product after the addition and manual agitation with the additive component.

In one embodiment, additional preparatory process or compatibilization may be used for one or more of the functional component, matrix forming component and the caloric component may be employed to improve dispersibility, decrease segregation, and improve ability to manually agitate the delivery vehicle in the additive component. For example, performing the additional preparatory process may be desirable when the functional component is difficult to dissolve. In addition, according to methods according to the present disclosure the combination, including at least a portion of each of the functional component, matrix forming component and the caloric component are compatibilized together. The additional preparatory process or compatibilization may include instantizing methods and/or agglomeration (for instance, as disclosed in U.S. Pat. No. 4,571,346, which is hereby incorporated by reference in its entirety). The agglomeration may create a substantially uniform and substantially homogenous matrix with a high level of dispersion. With agglomeration as the compatibilization process, manual agitation may be easier. This increased ease for manual agitation may be due to, in part, the increased dispersion within the matrix when the additive component is added. Additionally or alternatively, including lecithin as part of the functional component or stand-alone processing agent included during compatibilization may aid in the dispersion. The compatibilization process may result in increased shelf life and decreased degradation of the consumable product and/or the components of the consumable product. The additional compatibilization process may also be used for modifying the texture of the consumable product and/or reduce foaming in the consumable product.

The functional component is compatible with the matrix-forming component. “Compatibility”, “compatible”, “compatibilization” and grammatical variations thereof is defined as interaction or non-interaction between the components of the delivery vehicle such that the combined ingredients form a matrix and the matrix formed has a desired flavor, appearance, and texture. In one embodiment of the present disclosure, the functional component is sufficiently compatible to permit the formation of the matrix by the matrix-forming component. In another embodiment, the functional component interacts with the matrix-forming component and caloric component in a manner that assists or otherwise facilitates formation of the matrix. Compatibility may be provided in a variety of ways. For example, compatibility may be provided by selected additions, including selected concentrations, of particular functional components. For example, suitable functional components may include synergistic blends of combinations of fibers. In addition, compatibility may be provided by processing, or compatibilization, of the combined components in the delivery vehicle, or the functional components prior to adding to the delivery vehicle. Processing or compatibilization may include, but is not limited to processes such as, micronizing, micro or nanoencapsulating, agglomerating, dispersing, and/or instantizing the functional component. In addition, compatibilization may include processing for greater use and shelf-life (e.g., heat sensitive vitamins, fish oils, etc.).

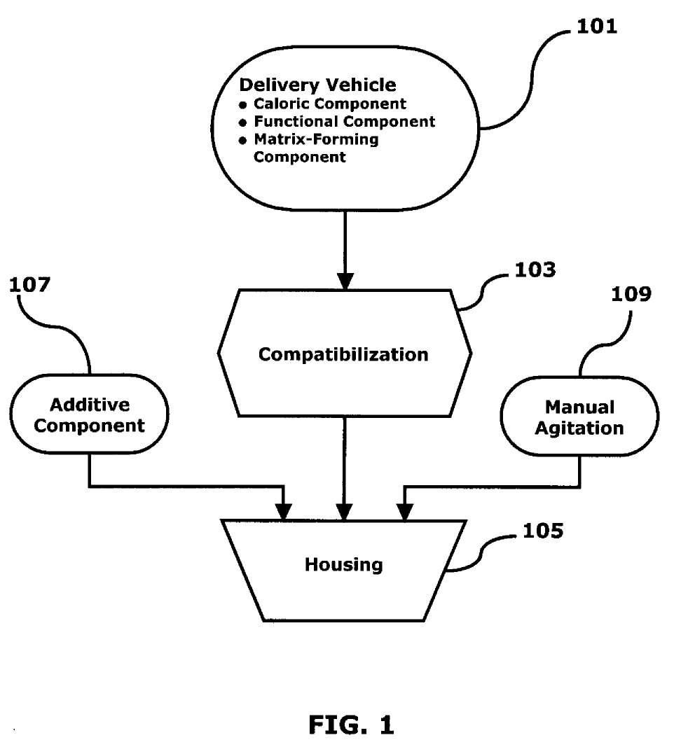

In one embodiment, the delivery vehicle may utilize preinstantized nutritional functional components or micronized components which are combined with the matrix-forming and caloric components and further processed by agglomeration or other instantizing methods and blending to allow for a substantially homogenous delivery vehicle that prevent segregation of functional components. As shown in FIG. 1, the method includes providing ingredients, including the functional component, matrix forming component and the caloric component, to a blended delivery vehicle, step 101. Thereafter, the combined deliver vehicle ingredients are compatibilized, step 103. The compatibilization may include any suitable process, such as micronizing, micro or nanoencapsulating, agglomerating, dispersing, or instantizing the combined ingredients. The compatibilization delivery vehicle is then provided to a housing, step 105. If additional components, such as coloring, flavoring or other ingredients are desired for the delivery vehicle, they may be blended with the compatibilized delivery vehicle. The method further includes addition of the additive component, step 105 and manual agitation, step 107, wherein the combined and manually agitated additive component and delivery vehicle form a substantially solid consumable product.

Puddings and gelatins are matrix systems that may be composed of thickening and gelling systems. In a nutritionally enhanced substantially solid pudding or gelatin system, compatibilization, such as agglomeration serves to improve dispersibility of the functional components in addition to improving dispersibility of flavoring components such as cocoa and matrix-forming components, such as starches in sugar free systems, and prevents segregation of individual components which may vary in particle size and densities. In an example where the matrix component is a thickening system, and the functional component includes protein and fiber, at least one protein source may be synergistically used for desired texture and flavor. For example, the proteins may be combined with fiber for added desired benefits. One suitable processing aid for agglomeration may include lecithin, where the lecithin levels may be adjusted to alter the texture and the flavor of the product. While not wishing to be bound by theory, lecithin breaks down the firmer texture in the pudding-type system that is provided by the matrix-forming components and the functional components, such as proteins. Use of preinstantized protein functional components, for example, use of instantized lecithinated whey protein concentrate may desirably affect texture and reduce the foaming characteristic of the product.

In one embodiment, for desirable satiation, the substantially solid consumable product may be served in a 5 to 6 ounce housing that holds at least about 140 mL or at least about 163 mL of liquid, depending on the type of system (e.g., gelatin vs. pudding system) with a caloric density between about 0.10 and about 0.95 (e.g., regular puddings=about 0.94, sugar-free puddings=about 0.60 to 0.61, regular gelatins =about 0.67, sugar-free gelatins=about 0.17) thereby permitting the product to be a substantial snack product, a mini-meal, or a meal replacement. Satiation may be provided by lowering caloric density, providing a substantial portion size, and/or providing satiating macrofunctional ingredients or specific isolated ingredients. It is desirable that the amount of additive component and matrix-forming component provide adequate portion size.

The functional component may include medicines and/or drugs. The drugs may be over-the-counter drugs or may be prescription drugs. Electrolytes for hydration may be included in the functional component. The housing may be specifically configured to administer drugs in desired dosages. For example, the housing may be configured for mixing drugs or medicine with the additive component and/or the matrix-forming component in specific, desired dosages, thereby permitting easier consumption of hard to swallow and/or bad tasting drugs or medicine.

Adding the additive component to the delivery vehicle and providing manual agitation may produce the substantially solid consumable product. The additive component is preferably a liquid. Suitable additive components include, but are not limited to, water, milk, fruit juice, soy milk, buttermilk, yogurt, and sour cream. The additive component, by addition to the matrix component and forming the delivery vehicle, may provide additional benefits including, but not limited to, enhancing retention time for digestion, benefits from the additive nutritional content, flavoring, etc. In a further embodiment, the additive component is mixed by a consumer prior to the consumer ingesting the substantially solid consumable product. This mixing by the consumer may be based upon predetermined recommendations of what liquid to add for a desired functional result or may permit the consumer flexibility in selecting the additive component added to the matrix-forming component. Additionally, the additive component may be added at varying temperatures based upon recommendations provided to the consumer or based upon the consumer's decision.

The substantially solid consumable product may be included in various other products. By way of example only, the substantially solid consumable product may be included in puddings, gelatin desserts, fruit dips, vegetable dips, spreads, yogurt mousse mixed, salad dressings, gravies, marinades, seasonings, condiments, and/or combinations thereof. The substantially solid consumable product may be consumed independently, may be consumed as an additive, may be consumed with foods, may be consumed with liquids, may be consumed with drugs, and/or any other consumable product. In embodiments of the substantially solid consumable product where the product is used as an additive, it may be used for favor enhancement, seasoning, or any other purpose.

### EXAMPLE

Examples 1 through 16 illustrate the versatility of adding several specific ingredients to the base composition. Although these examples focus on gelatin, as described above, the base composition may include additional or alternative ingredients. Examples 1 through 16 of the present disclosure include a base composition with a matrix-forming component of gelatin, a caloric component of sugar, and a first functional component of soluble corn fiber in about the following quantities (by weight percent):

Base Composition:

| | | |
|---|---|---|
| Matrix-forming Components: | gelatin | 7% (+/−1%) |
| | Citric/fumaric acid | 1.5% (+/−0.5%) |
| | sodium citrate | 1.25% (+/−0.25%) |
| Caloric Component: | sugar | 67% (+/−3%) |
| First Functional Component: | soluble corn fiber | 17% (+/−3%) |
| Additive Component: | ⅔ cup hot water | (150° F. +/− 5° F.) |

Functional properties of various formulations of the substantially solid consumable product were tested for texture, appearance and flavor. In each of these examples, about 35 grams of the above base composition was mixed with additional functional components and then refrigerated (at about 45° F.) for between about 4 and about 5 hours. The texture, flavor, and appearance were rated between one and nine with nine being the most desirable by two experienced food tasting subjects. The results of the testing are summarized in TABLE 2.

TABLE 2

| | | | Second Functional | Texture | Flavor |
|---|---|---|---|---|---|
| Example | Amount | | Component | Rating | Rating |
| Comp. 1 | | | none | 9 | 9 |
| 1 (protein) | 2.7 | grams | whey protein isolate | 8 | 2 |
| 2 (protein) | 2.7 | grams | whey protein isolate | 7 | 7 |
| 3 (protein) | 2.7 | grams | Ca caseinate | 7 | 7 |
| 4 (fiber) | 7.2 | grams | soluble corn fiber | 9 | 9 |
| 5 (fiber) | 7.2 | grams | inulin | 9 | 9 |
| 6 (fiber) | 7.2 | grams | benefiber | 4 | 5 |
| 7 | .3 | grams | turmeric spice | 8 | 5 |
| (antioxidant) | | | | | |
| 8 | 2 | grams | orange fruit powder | 8 | 7 |
| (antioxidant) | | | | | |
| 9 | .1 | grams | vitamin C | 9 | 8 |
| (antioxidant) | | | | | |
| 10 (mineral) | 1 | gram | Calcium lactate | 8 | 7 |
| | | | gluconate | | |
| 11 (mineral) | 1 | gram | aquamin souble | 8 | 7 |
| 12 (mineral) | .5 | grams | TCP aka dry | 1 | 1 |
| | | | calcium carbonate | | |
| 13 (other) | .2 | grams | caffeine | 9 | 3 |
| 14 (other) | .3 | grams | white tea solids | 9 | 8 |
| 15 (additive | | | black tea added via | 2 | 2 |
| component | | | additive component | | |
| was replaced) | | | | | |
| 16 (additive | | | fruit juice added via | 9 | 8 |
| component | | | additive component | | |
| was replaced) | | | | | |

In Comparative Example 1 (a control), the base material was mixed with additive component. The texture was rated nine and the flavor was rated nine.

Examples 1 through 3 illustrate the effect of proteins on the base composition. In Example 1, about 2.7 grams of “whey protein isolate” (available from Hilmar Whey Protein Inc., Hilmar Calif.) were mixed with the base composition. In this formulation, the substantially solid consumable product produced included a foamy layer. The texture was rated eight and the flavor was rated two. In Example 2, about 2.7 grams of “whey protein isolate—190” (available from Glanbia Nutritionals, Monroe, Wis.) were mixed with the base composition. In this formulation, the substantially solid consumable product produced included a foamy layer. Upon removing the foamy layer, the texture was rated seven and the flavor was rated seven. In Example 3, about 2.7 grams of “Ca Caseinate” (available from Erie Foods International, Erie, Ill.) were mixed with the base composition. In this formulation, the substantially solid consumable product precipitated. The texture was rated seven and the flavor was rated seven. The example illustrated the desirability to use water soluble proteins in the matrix; however, even with water soluble proteins in the matrix, foam still may result. As such, it may be desirable to include antifoaming agents, modify the processing step so that the entire mix is agglomerated, and/or include instantized, lecithinated proteins.

Examples 4 through 6 illustrate the effect of fibers on the base composition. In Example 4, about 7.2 grams of “soluble corn fiber” (available from Tate & Lyle PLC, London, England) were mixed with the base composition. The texture was rated nine and the flavor was rated nine. In Example 5, about 7.2 grams of “inulin” (available from Cargill, Inc., Minneapolis, Minn.) were mixed with the base composition. The texture was rated nine and the flavor was rated nine. In Example 6, about 7.2 grams of “Benefiber” (available from Novartis Consumer Health, Parsippany, N.J.) were mixed with the base composition. The texture was rated four and the flavor was rated five. The results illustrated that soluble fibers including, but not limited to, soluble corn fibers, dextrins, chicory root extract and/or a blend of fibers (which may help avoid gastrointestinal discomfort) may be added in doses up to about 10 to about 16 grams per serving or about 30% to about 50% of the Daily Recommended Value. For instance, about 5 grams of inulin or chicory root extract may be combined with about 2 to about 5 grams of soluble corn fiber or dextrin. Use of instantized fibers may be desirable for enhanced solubility. Additionally, it may be desirable to choose fibers with a negligible amount of residual sugars, thereby producing a final product that may be labeled sugar free. It may be desirable to add fiber in a range of about 0.5 grams to about 16 grams per serving.

Examples 7 through 9 illustrate the effect of antioxidants on the base composition. In Example 7, about 0.3 grams of “turmeric spice” (available from McCormick, Maryland]) were mixed with the base composition. The texture was rated eight and the flavor was rated five. In Example 8, about 2 grams of “orange fruit powder” (available from Kerry Ingredients, New Century, Kans.) were mixed with the base composition. The texture was rated eight and the flavor was rated seven. In Example 9, about 0.1 grams of “vitamin C” (available from Premium Ingredients, Illinois]) were mixed with the base composition. The texture was rated nine and the flavor was rated eight. Examples 7 through 9 illustrate that the delivery vehicle may deliver a wide range of nutritive enhancing functional ingredients without significantly affecting texture, flavor or appearance. Additionally, Examples 7 through 9 illustrate that although the flavor may be affected, it may be remedied by the addition of flavor modifying and/or masking agents.

Examples 10 through 12 illustrate the effect of minerals on the base composition. In Example 10, about 1 gram of “Calcium lactate gluconate” (available from Barrington Nutritionals, Harrison, N.Y.) were mixed with the base composition. The texture was rated eight and the flavor was rated seven. In Example 11, about 1 gram of “aquamin souble” (available from GTC Nutrition, Golden, Colo.) were mixed with the base composition. The texture was rated 8 and the flavor was rated 7. In Example 12, about 0.5 grams of “Tri Calcium Phosphate” or dry Calcium Carbonate (available from Gadot Biochemical Industries Ltd., Haifa Bay, Israel) were mixed with the base composition. In this formulation, the substantially solid consumable product was bitter. The texture was rated 1 and the flavor was rated 1. Generally, “TriCalcium Phosphate” is not as soluble as “Calcium lactate glutonate.” Thus, the lower results for Example 12 in comparison to the higher results in Example 10 illustrates that water solubility is desirable for adding minerals to the base composition.

Examples 13 and 14 illustrate the effect of other ingredients on the base composition. In Example 13, about 0.2 grams of caffeine (available from Barrington Nutritionals, Harrison, N.Y.) were mixed with the base composition. In this formulation, the substantially solid consumable product was bitter. The texture was rated 9 and the flavor was rated 3. In Example 14, about 0.3 grams of white tea solids (available from Wild Flavors, Kentucky]) were mixed with the base composition. The texture was rated 9 and the flavor was rated 8. This example illustrates that the base composition is a desirable matrix system for tea extracts including but not limited to white tea, green tea, black tea, oolong tea, red tea which provide high antioxidant values (ORAC/Total Polyphenols). Other types of water-soluble extracts may be added to boost the anti-oxidant value.

Examples 15 and 16 illustrate the effect of alternative additive components. In Example 15, the matrix was mixed with freshly brewed black tea instead of water. The texture was rated 2 and the flavor was rated 2. In Example 16, the matrix was mixed with V-8 fusion flavored fruit juice. The texture was rated 9 and the flavor was rated 8. Examples 15 and 16 illustrate that it is desirable to use fruit juice to mix the matrix.

Examples 17 through 19 illustrate the effect of natural flavors on the clarity of the final product. For instance, natural flavors including citrus oil unexpectedly may result in cloudiness of the final product. As illustrated in TABLE 3, in Example 17, natural orange color was added to the above base composition. The resulting product remained clear. In Example 18, natural strawberry flavor and natural orange color were added to the above base composition. The resulting product also remained clear. However, as illustrated in Example 19, natural orange flavor and natural orange color added to the above base composition resulted in a cloudy product indicating that the natural orange flavor interfered with the clarity.

TABLE 3

| Example | Flavor + Color Combination | Clarity |
|---|---|---|
| 17 | No flavor + natural orange color | clear |
| 18 | Natural Strawberry flavor + natural orange color | clear |
| 19 | Natural Orange flavor + natural orange color | cloudy |

INSTANT PUDDING: Instant pudding examples were prepared using matrix forming component comprised primarily of starches which are thickening agents and gel setting agents such as alkali metal orthophosphates and pyrophosphates that form a pudding system when added to milk. Examples 20-25 include formulations of substantially solid instant puddings with enhanced proteins, fiber and calcium levels by use of functional components, as shown in the below examples.

Base Composition:

| | | | |
|---|---|---|---|
| Matrix-forming | Modified Food Starch | 6 | g (+/−1 g) |
| Components: | Cocoa | 3 | g (+/−1 g) |
| | Disodium phosphate | 1.075 | g (+/−0.135 g) |
| | Tetrasodium phosphate: | 0.45 | g (+/−0.05 g) |
| | Tricalcium phosphate: | 0.35 | g (+/−0.15 g) |
| | Salt: | 0.1 | g (+/−0.1 g) |
| | Colors/Flavors: | 0.05-0.5 | grams |
| Caloric Component: | Fructose | 8 | g (+/−1 gram) |
| | Sugar | 13 | g (+/−1 gram) |
| Functional | Fiber/Fiber Blend | 5.5 | g (+/−0.5 g) |
| Components: | Protein/Protein Blend | 5.75 | (+/−0.75 g) |
| Additive | ⅔ cup skim milk | | |
| Component: | | | |

Functional properties of various formulations of the substantially solid consumable product were tested for texture and flavor. In each of these examples, about 35-38 grams of the above base composition was mixed with additional functional components and then refrigerated (at about 45° F.) for between about 5 to 10 minutes. The texture, flavor, and appearance were rated between 1 and 9 with 9 being the most desirable by two experienced food-tasting subjects. The results of the testing are summarized in TABLE 4. In example 25, no salt was added. It is desirable to eliminate salt or use non salt alkali metal phosphates in order to reduce the sodium content of the consumable product. A blend of chosen phosphates such as dipotassium phosphate and tetrasodium pyrophosphate provides a good ratio of potassium: sodium that makes the consumable product a healthier option.

TABLE 4

| Example | Protein | Texture | Flavor |
|---|---|---|---|
| 20 | WPI: 6.5 g | 1-soupy | 2 |
| 21 | WPC:MPC (3.3 + 3.1) | 5-not firm enough | 4 |
| 22 | MPC:CaCaes (3.4 + 3.1) | 2-did not set | 2-hay |
| | | | like flavor |
| 23 | WPI:CaCaes (2.5 + 4) | 2-lumpy, did not set | 2-off flavor |
| 24 | WPC:CaCaes (2.7 + 3.8) | 6 | 4 |
| 25 | WPC:Caes (2.0 + 3.9) | 8 | 7 |

WPI (“Whey Protein Isolate”)
WPC (“Whey Protein Concentrate”)
CaCaes (“Ca Caseinate”)
Caes (“Caseinate”)
MPC (“Milk Protein Concentrate”)

WHOLE GRAIN PUDDING: A formula substantially identical to the above instant pudding was formulated to deliver whole grains. Whole grain ingredient—Soft Ultragrain (ConAgra Ingredients, Nebraska) was used. Matrix component of 38 grams was combined with 12 grams of a functional component of whole grains and 0.27 grams of additional starch. The mixture was combined and 2/3 cup skim milk stirred into it. The mix had a slight gritty texture but was acceptable. The finished product contained protein, fiber, calcium and whole grain. Whole grains could vary from as little as 2 grams to as high as 16 grams with minimal impact on texture and flavor. Whole grains are typically delivered in cooked or baked products but this example shows that whole grains can be delivered in a dry mix delivery matrix system. By undergoing a processing step such as agglomeration with a certain temp/time process or by properly sterilizing the whole grain functional component, the microbial count of the dry mix will be safe for consumption.

PROBIOTIC YOGURT PUDDING WITH FRUIT: A formula substantially identical to the above instant pudding was formulated to form a yogurt-like product. Approximately 38 grams of the base formula indicated above for the instant pudding was combined with 12 grams of spray dried strawberry powder (available from Kerry Ingredients, Beloit, Wis.), 0.76 grams of citric acid, 3.72 grams of non fat yogurt powder (Suttons Bay, Mich.), 0.228 grams of modified starch and 1.0 grams of a probiotic culture, Florafit® (available from Danisco, Bakerfield, Calif.). The mix was blended and then combined with ⅔ cup skim milk. After allowing to set for 5 minutes, the resulting product had a substantially identical flavor and texture of a commercially available stirred yogurt.

While the disclosure has been described with reference to a preferred embodiment, it will be understood by those skilled in the art that various changes may be made and equivalents may be substituted for elements thereof without departing from the scope of the disclosure. For instance, the materials disclosed as comprising the embodiments are exemplary and not exhaustive. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A composition comprising:
a delivery vehicle comprising a caloric component, a functional component, and a matrix-forming component, the matrix-forming component being selected from the group consisting of a thickening agent, gelling agent, an emulsifier, and combinations thereof, each of the caloric component and the functional component being substantially homogenously mixed within the delivery vehicle, the functional component being compatible with the matrix forming component;
wherein at least a portion of each of the caloric component, the functional component, and the matrix-forming component have been compatibilized together; and
wherein the delivery vehicle is arranged and disposed to receive an additive component thereby producing a substantially solid consumable product upon manual agitation.

2. The composition of claim 1, wherein the delivery vehicle comprises from about 4% to about 25% of the substantially solid consumable product.

3. The composition of claim 2, wherein the delivery vehicle includes gelatin.

4. The composition of claim 2, wherein the delivery vehicle includes pudding.

5. The composition of claim 1, wherein at least a portion of each of the caloric component, the functional component, and the matrix-forming component have been compatibilized by a method selected from the group consisting of micronizing, micro or nanoencapsulating, agglomerating, dispersing, instantizing and combinations thereof.

6. The composition of claim 5, wherein at least a portion of each of the caloric component, the functional component, and the matrix-forming component have been compatibilized by agglomerating.

7. The composition of claim 1, further comprising the additive component.

8. The composition of claim 7, wherein the additive components is selected from the group consisting of water, milk and combinations thereof.

9. The composition of claim 1, wherein the functional component is selected from the group consisting of soluble corn fiber, proteins, calcium, vitamins, inulin, dextrin, synergistic blends to avoid gastric discomfort, antioxidant extracts, tea extracts, whole grains, probiotic cultures, prebiotic cultures, and combinations thereof.

10. The composition of claim 1, wherein the functional component provides features selected from the group consisting of nutritive features, satiating features, sensory features, water absorption, caloric density, promotion of proteins, promotion of fiber, promotion of functional lipid chemistry, clarity, and combinations thereof.

11. The composition of claim 1, wherein the composition forms a substantially clear substantially solid consumable product when the composition is manually agitated with the additive component.

12. The composition of claim 1, wherein the composition is substantially devoid of artificial flavors and synthetic colors.

13. The composition of claim 1, wherein the delivery vehicle is an agglomerated mixture.

14. A substantially solid consumable product system comprising:
a composition comprising:
a delivery vehicle a caloric component, a functional component, and a matrix-forming component, the matrix-forming component being selected from the group consisting of a thickening agent, a gelling agent, an emulsifier, and combinations thereof, each of the caloric component and the functional component being substantially homogenously mixed within the delivery vehicle, the functional component being compatible with the matrix forming component;
wherein at least a portion of each of the caloric component, the functional component, and the matrix-forming component have been compatibilized together; and
wherein the delivery vehicle is arranged and disposed to receive an additive component thereby producing a substantially solid consumable product upon manual agitation; and
a housing arranged for receiving the additive component and disposed for securing the substantially solid consumable product.

15. The substantially solid consumable product of claim 14, wherein the delivery vehicle comprises from about 4% to about 25% of the substantially solid consumable product.

16. The substantially solid consumable product of claim 15, wherein the delivery vehicle includes gelatin.

17. The substantially solid consumable product of claim 15, wherein the delivery vehicle includes pudding.

18. The substantially solid consumable product of claim 14, wherein the functional component is selected from the group consisting of soluble corn fiber, proteins, calcium, vitamins, inulin, dextrin, synergistic blends to avoid gastric discomfort, antioxidant extracts, tea extracts, whole grains, probiotic cultures, prebiotic cultures, and combinations thereof.

19. The substantially solid consumable product of claim 18, wherein at least a portion of each of the caloric component, the functional component, and the matrix-forming component have been compatibilized by agglomerating.

20. The substantially solid consumable product of claim 14, wherein the additive components is selected from the group consisting of water, milk and combinations thereof.

21. The substantially solid consumable product of claim 14, wherein the functional component is selected from the group consisting of additional soluble corn fiber, proteins, calcium, vitamins, inulin, dextrin, synergistic blends to avoid gastric discomfort, and combinations thereof.

22. The substantially solid consumable product of claim 14, wherein the functional component provides features selected from the group consisting of nutritive features, satiating features, sensory features, water absorption, caloric density, promotion of proteins, promotion of fiber, promotion of functional lipid chemistry, clarity, and combinations thereof.

23. The composition of claim 14, wherein the composition forms a substantially clear substantially solid consumable product.

24. The substantially solid consumable product of claim 14, wherein the substantially solid consumable product is substantially devoid of artificial flavors and synthetic colors.

25. A method of preparing a substantially solid consumable product comprising:
providing a composition, the composition comprising:
a delivery vehicle a caloric component, a functional component, and a matrix-forming component, the matrix-forming component being selected from the group consisting of a thickening agent, a gelling agent, an emulsifier, and combinations thereof, each of the caloric component and the functional component being substantially homogenously mixed within the delivery vehicle, the functional component being compatible with the matrix forming component; and
compatibilizing together at least a portion of each of the caloric component, the functional component, and the matrix-forming component;
arranging and disposing the delivery vehicle in a housing to receive an additive component; and
providing the additive component to the delivery vehicle; and
manually agitating the additive component and delivery vehicle to produce a substantially solid consumable product.

26. The method of claim 25, wherein:
the delivery vehicle comprises about 23% to about 31.5% of the matrix, the delivery vehicle including about 1% to about 2% citric acid in the matrix, and about 1% to about 1.5% sodium citrate in the matrix, and about 15% to about 20% soluble corn fiber in the matrix;
the delivery vehicle includes gelatin;
the caloric component comprises at least about 65% of the matrix, the caloric component being substantially sugar;
the functional component is selected from the group consisting of soluble corn fiber, proteins, calcium, vitamins, inulin, dextrin, synergistic blends to avoid gastric discomfort, and combinations thereof, and
the functional component is arranged and disposed for providing nutritive features, satiating features, sensory features, water absorption, caloric density, promotion of proteins, promotion of fiber, promotion of functional lipid chemistry, clarity, and combinations thereof.

27. The method of claim 25, wherein:
the delivery vehicle is includes pudding; and
the functional component includes protein, fiber and one or more of whole grains, or yogurt blends, wherein the yogurt blend includes a blend of fruit powders, yogurt powder, and probiotic cultures.
